(19) United States
(12) Patent Application Publication
(10) Pub. No.: US 2017/0067416 A1
(43) Pub. Date: Mar. 9, 2017

(54) MANUFACTURING METHOD FOR A HOUSING OF AN EXHAUST GAS RECIRCULATION COOLER AND HOUSING PANEL STRUCTURE THEREFOR

(71) Applicants: Kim Do Young, Gyeonggi-do (KR); Seo Hyoung Jun, Gyeonggi-do (KR); Su Hwan Kim, Incheon (KR); Park Jun Young, Seoul (KR)

(72) Inventors: Kim Do Young, Gyeonggi-do (KR); Seo Hyoung Jun, Gyeonggi-do (KR); Su Hwan Kim, Incheon (KR); Park Jun Young, Seoul (KR)

(73) Assignee: SAMBO MOTORS, Daegu (KR)

(21) Appl. No.: 14/845,578

(22) Filed: Sep. 4, 2015

(51) Int. Cl. F02M 26/29

(52) U.S. Cl. CPC F02M 26/29

(57) ABSTRACT

Disclosed herein is a housing panel of an exhaust gas recirculation cooler which is used to manufacture a housing that houses therein a cooling module for cooling recirculation exhaust gas of a vehicle. The housing panel includes a pair of pre-side surface parts which forms respective side surface parts of the housing, and a pre-upper surface part which forms an upper surface part of the housing and is integrally formed between the pair of pre-side surface parts. Two bending parts each having an obtuse angle are formed in the pre-upper surface part at positions spaced apart from each other by a predetermined distance. The torsion caused by stress can be reduced, and the flatness and strength can be enhanced.

### BACKGROUND OF THE INVENTION

Field of the Invention

Exemplary embodiments of the present invention relate to a cooler for an exhaust gas recirculation apparatus, and more particularly, to a method for manufacturing a housing which houses therein a cooler of an exhaust gas recirculation apparatus, and a structure of a panel as a part used to manufacture the housing.

Description of the Related Art

Generally, an exhaust gas recirculation (EGR) apparatus is an apparatus which recirculates exhaust gas to an intake manifold of a combustion chamber so as to reduce emission of NOx, which is a kind of regulated emission material of exhaust gas, and thus reduces the temperature in the combustion chamber, thereby reducing generation of NOx.

Such an EGR apparatus includes an EGR valve which controls an EGR flow rate in response to operating conditions of an engine under the control of an engine control unit (ECU), and an EGR cooler which cools exhaust gas by means of heat exchange with coolant before the exhaust gas is recirculated to the intake manifold.

As shown in FIGS. 1 and 2, a conventional EGR cooler includes a cooling module 101 in a housing and is configured such that recirculation exhaust gas passes through the interior of the cooling module 101 and is cooled by means of heat exchange with coolant before being discharged to a combustion chamber.

The housing is manufactured in such a way that an upper housing 102 and a lower housing 103 are separately formed and then coupled to each other. The upper housing 102 and the lower housing 103 are manufactured to have U shapes and then coupled to each other to form the housing having a rectangular frame shape.

However, because it is difficult to manufacture the U-shaped housings through a pressing process, each U-shaped housing having two corner parts 104 are manufactured in such a way that a planar panel is formed through a pressing process and then is bent twice through a bending process.

The bending process must be conducted twice to form the two corner parts 104. Therefore, torsion is increased by stress resulting from bending. Thereby, there is a problem of reduction in flatness. Particularly, since the degree of torsion varies whenever the housings are manufactured, the quality of products is not uniform.

Furthermore, the housing of the conventional EGR cooler may be easily twisted or deformed by residual stress generated when the pressing process is conducted. As a result, it is difficult to maintain the flatness, and the housings become vulnerable to external force or internal pressure.

### SUMMARY OF THE INVENTION

Accordingly, the present invention has been made keeping in mind the above problems occurring in the conventional method for manufacturing a housing of an exhaust gas recirculation cooler and a housing panel therefor, and an object of the present invention is to provide a method for manufacturing a housing of an exhaust gas recirculation cooler which can reduce torsion caused by stress and thus enhance the flatness and strength, and to a housing panel therefor.

In accordance with one aspect of the present invention, a housing panel of an exhaust gas recirculation cooler which is used to manufacture a housing that houses therein a cooling module for cooling recirculation exhaust gas of a vehicle includes: a pair of pre-side surface parts forming respective side surface parts of the housing; and a pre-upper surface part forming an upper surface part of the housing, the pre-upper surface part being integrally formed between the pair of pre-side surface parts, with two bending parts formed in the pre-upper surface part at positions spaced apart from each other by a predetermined distance, each of the two bending parts having an obtuse angle.

In the housing panel in accordance with an aspect of the present invention, the pre-upper surface part may include: a pair of first upper surface parts each integrally provided at a right angle on an edge of the corresponding pre-side surface part; and a second upper surface part provided between the pair of first upper surface parts, with an obtuse angle formed between the second upper surface part and each of the first upper surface parts by the corresponding bending part.

In the housing panel in accordance with another aspect of the present invention, a bead part for deformation prevention may be formed in a depressed form in the pre-upper surface part of the housing.

In the housing panel in accordance with another aspect of the present invention, the bead part may be formed in each of the bending parts.

In the housing panel in accordance with another aspect of the present invention, the bead part may comprise bead parts formed in the respective first upper surface parts to be symmetrical with each other based on the second upper surface part.

In accordance with yet another aspect of the present invention, a method for manufacturing a housing of an exhaust gas recirculation cooler includes: forming the housing panel; and flattening, through bending, the bending parts of the housing panel made in forming the housing panel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a housing of an exhaust gas recirculation cooler according to a conventional technique;

FIG. 2 is an assembled perspective view of FIG. 1;

FIG. 3 is a perspective view illustrating a housing of an exhaust gas recirculation cooler according to an exemplary embodiment of the present invention;

FIG. 4 is a plan view of an upper housing shown in FIG. 3;

FIG. 5 is a side sectional view taken along line A-A of FIG. 4;

FIGS. 6A and 6B are perspective view illustrating a method for manufacturing a housing of an exhaust gas recirculation cooler according to an exemplary embodiment of the present invention;

FIG. 7 is a perspective view illustrating a housing panel of an exhaust gas recirculation cooler manufactured according to an exemplary embodiment of the present invention; and

FIG. 8 is a side sectional view of the housing panel shown in FIG. 7.

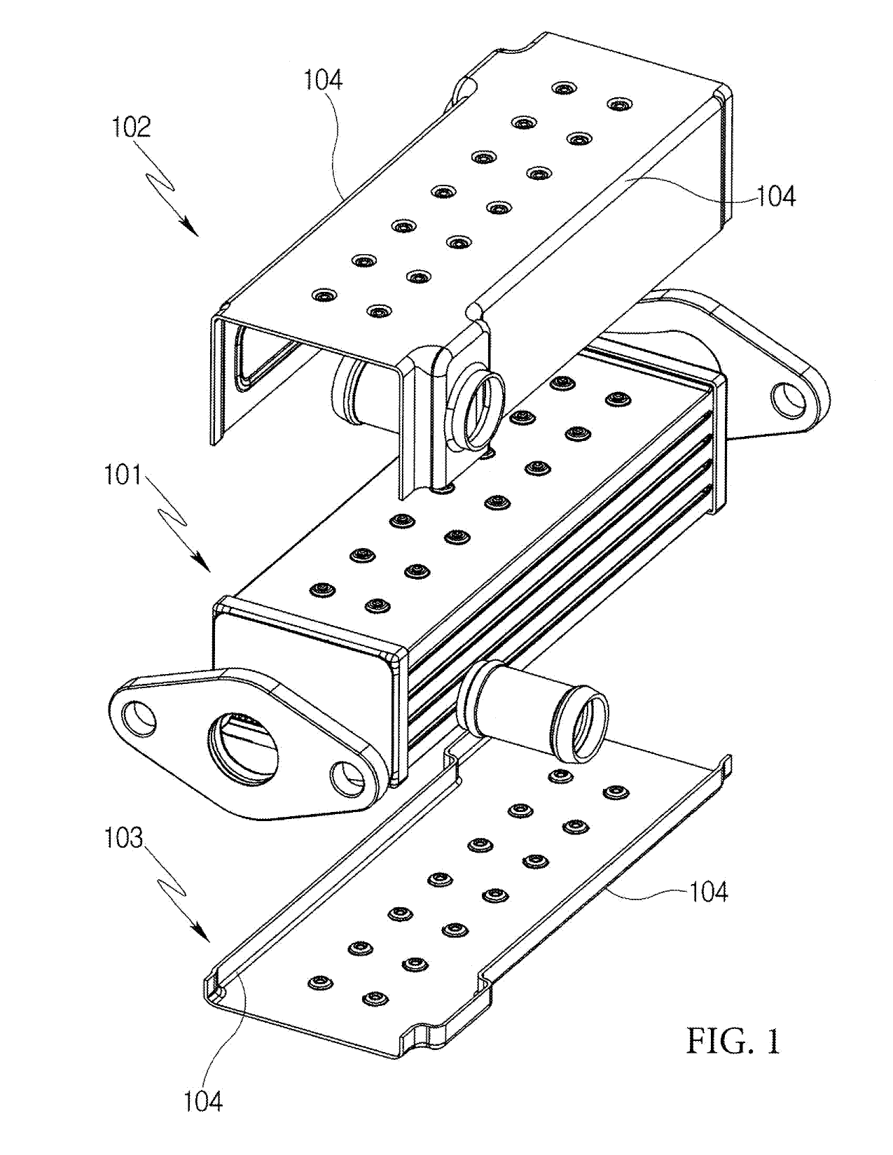

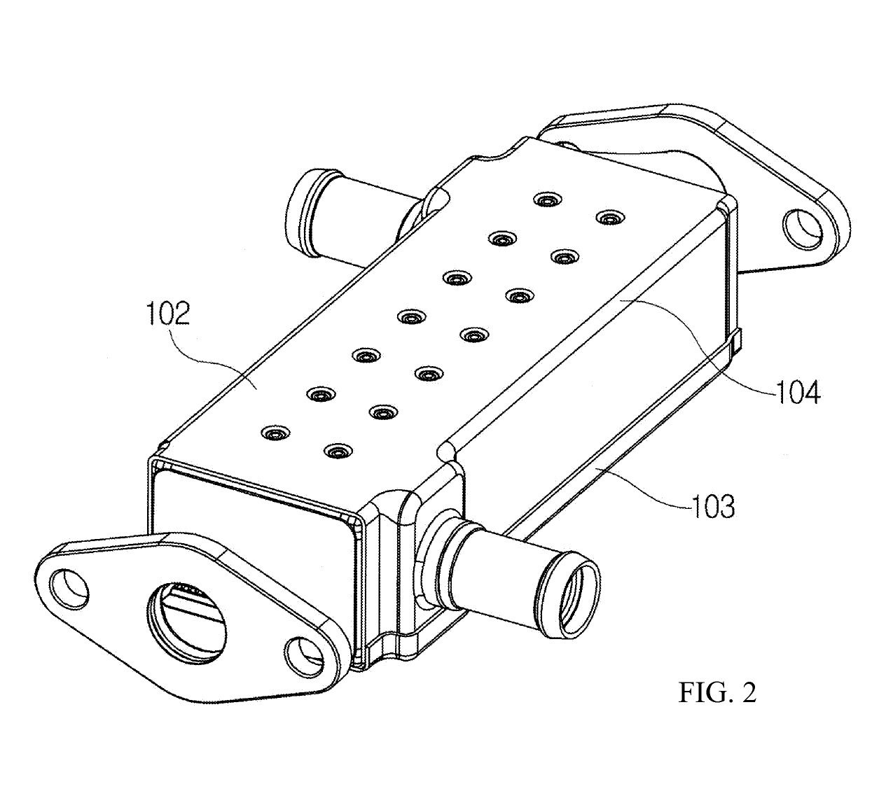

### DESCRIPTION OF SPECIFIC EMBODIMENTS

Hereinafter, an exemplary embodiment of the present invention will be described in detail with reference to the attached drawings.

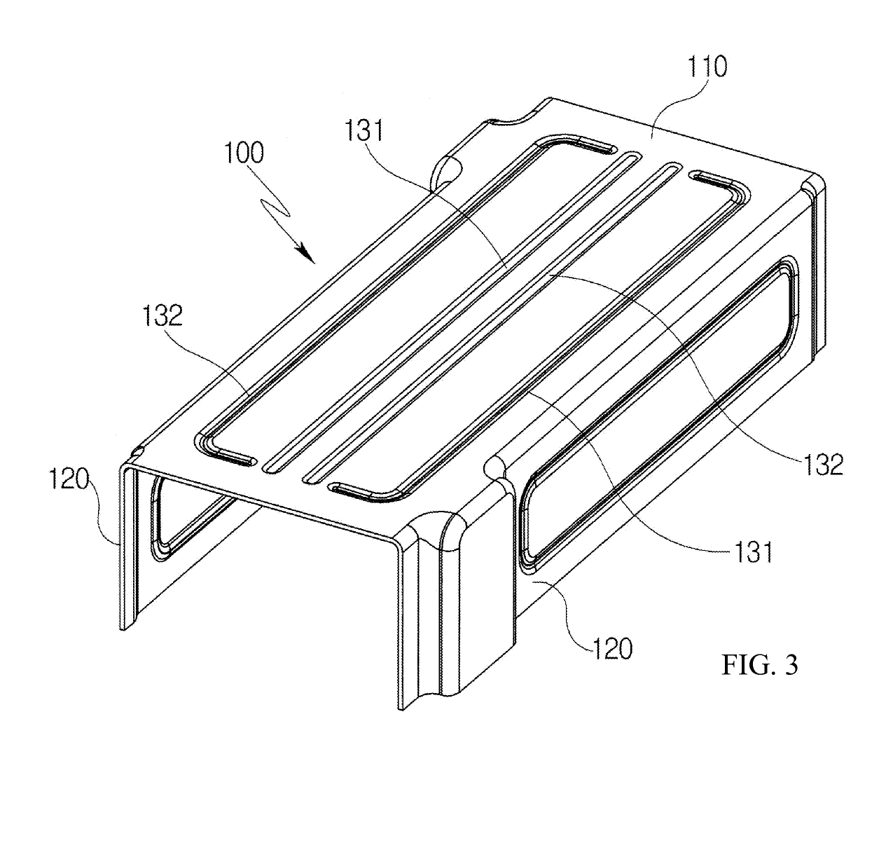

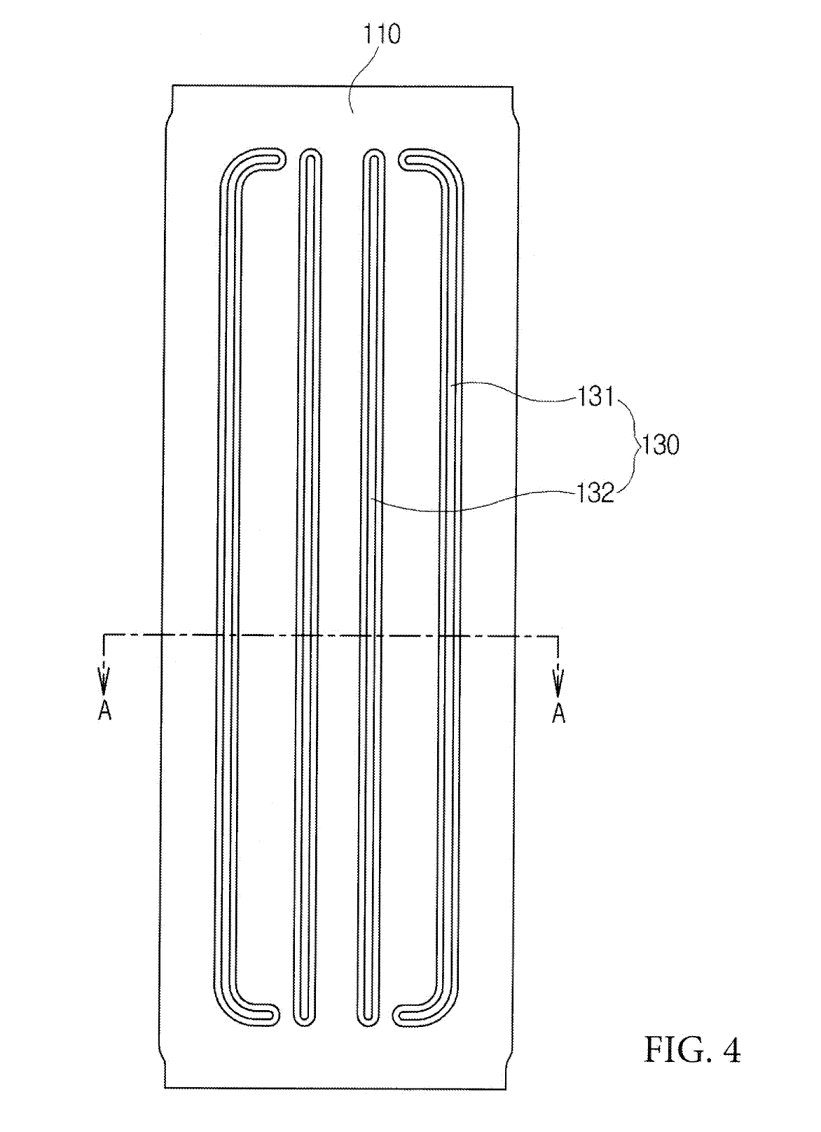

Referring to FIGS. 3 through 5, a housing of an exhaust gas recirculation cooler that is manufactured according to the exemplary embodiment of the present invention is formed in a form of a thin rectangular frame in such a way that an upper housing 100 and a lower housing (not shown) are separately manufactured and then assembled with each other.

The upper housing 100 includes an upper surface part 110 and a pair of side surface parts 120. The side surface parts 120 are formed to be perpendicularly bent from respective opposite edges of the upper surface part 110. The upper surface part 110 and the side surface parts 120 generally form a V′ shape.

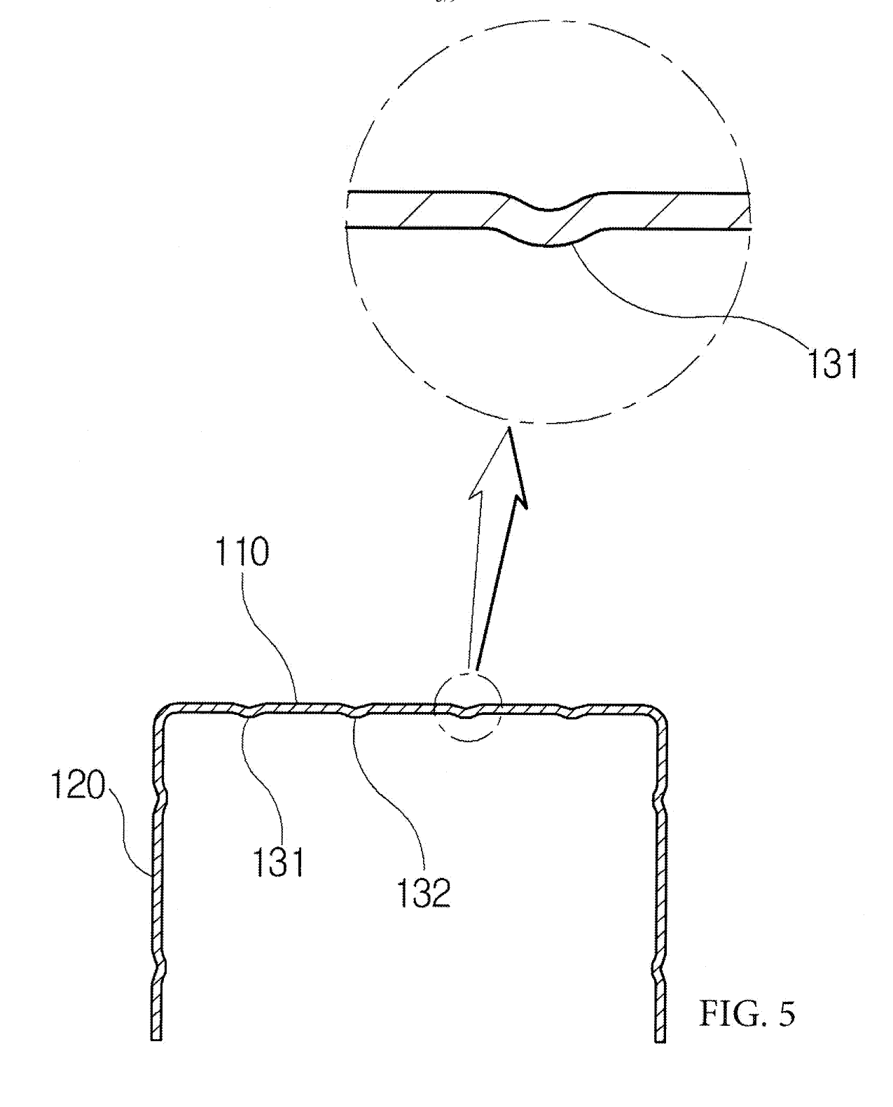

Bead parts 130 are formed in the upper surface part 110 and the side surface parts 120 of the housing 100. As shown in FIG. 5, the bead parts 130 are formed by depressing portions of outer surfaces of the upper surface part 110 and the side surface parts 120 in such a way that, as shown in the sectional view, each bead part 130 protrudes to a side opposite to the corresponding outer surface by a depth to which it is depressed. That is, for the upper surface part 110, the corresponding bead parts 130 each have a depression shape in an upper surface thereof and have a protrusion shape on a lower surface thereof. Each bead part 130 is formed such that the thickness of the cross-section thereof is the same as that of a portion surrounding the bead part 130. These bead parts 130 may be formed through a pressing process.

The bead parts 130 include a first bead 131 and a second bead 132, which is linear. The first bead 131 is formed in a U shape along the perimeter of the upper surface part 110. The second bead 132 is formed in a rod shape. In the present embodiment, a pair of first beads 131 and a pair of second beads 132 are provided such that they are formed to be symmetrical with each other in the upper surface part 110 at positions spaced apart from each other by predetermined distances.

As such, the bead parts 130 are formed in the upper surface part 110 and the side surface parts 120 in the transverse direction thereof and also formed linearly in the longitudinal direction thereof, whereby torsion attributable to stress can be reduced. Consequently, the flatness of each surface part can be enhanced, and the strength thereof against external force or internal pressure can be increased.

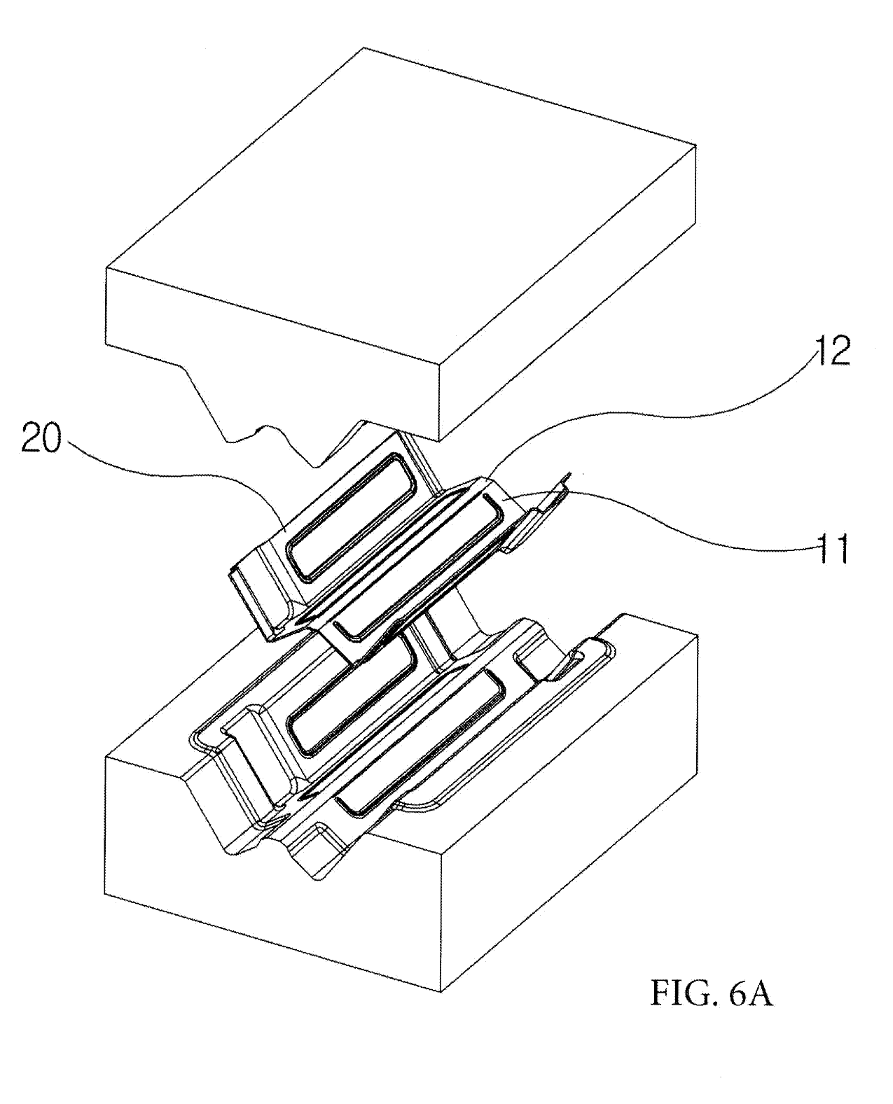

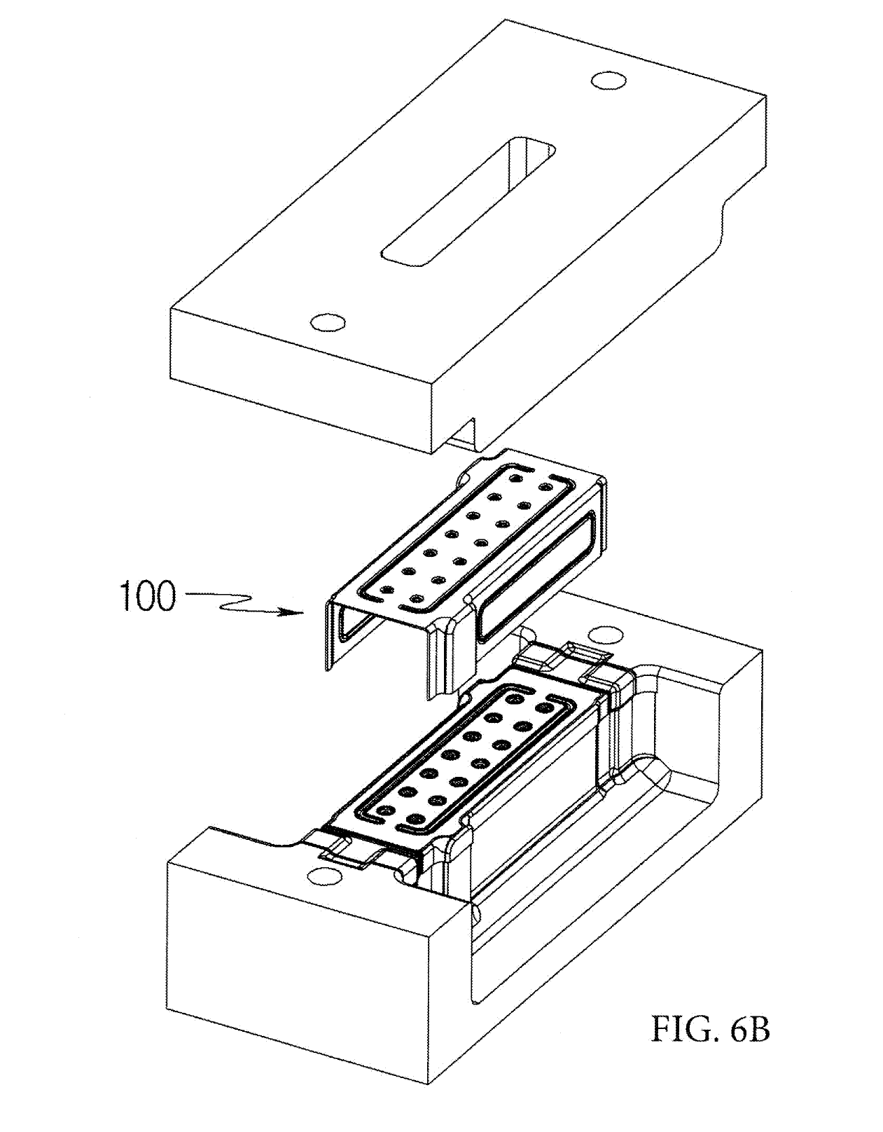

Hereinbelow, a method for manufacturing the housing of the exhaust gas recirculation cooler will be described with reference to FIGS. 6A to 8.

First, as shown in FIG. 6A, a housing panel 1 is formed by pressing a flat plate.

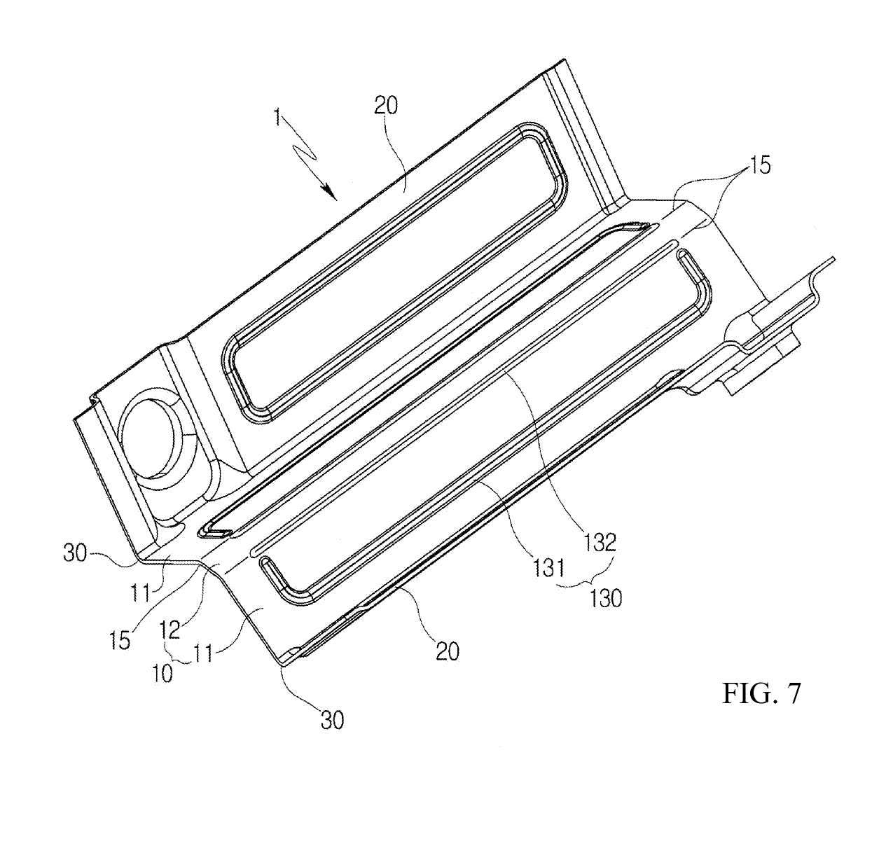

The housing panel 1 illustrated in FIG. 7 has a bent shape with two corner parts 30 and two bending parts 15. The housing panel 1 includes a pair of pre-side surface parts 20 which form the respective side surface parts 120 of the upper housing 100, and a pre-upper surface part 10 which forms the upper surface part 110 of the upper housing 100.

The pre-upper surface part 10 includes a pair of first upper surface parts 11 each of which perpendicularly and integrally extends from an edge of the corresponding pre-side surface part 20, and a second upper surface part 12 which is provided between the first upper surface parts 11 with an obtuse angle formed between the second upper surface part 12 and each first upper surface part 11 by the corresponding bending part 15.

The first upper surface parts 11 and the second upper surface part 12 are integrally formed between the two pre-side surface parts 20. The two bending parts 15, each of which has an obtuse angle, are formed at positions spaced apart from each other by a predetermined distance. The second upper surface part 12 is formed in the same shape as the final shape of the upper surface part 110 of the upper housing 100. The first upper surface parts 11 are bent around the bending parts 15 through a bending process so that the first upper surface parts 11 are level with the second upper surface part 12.

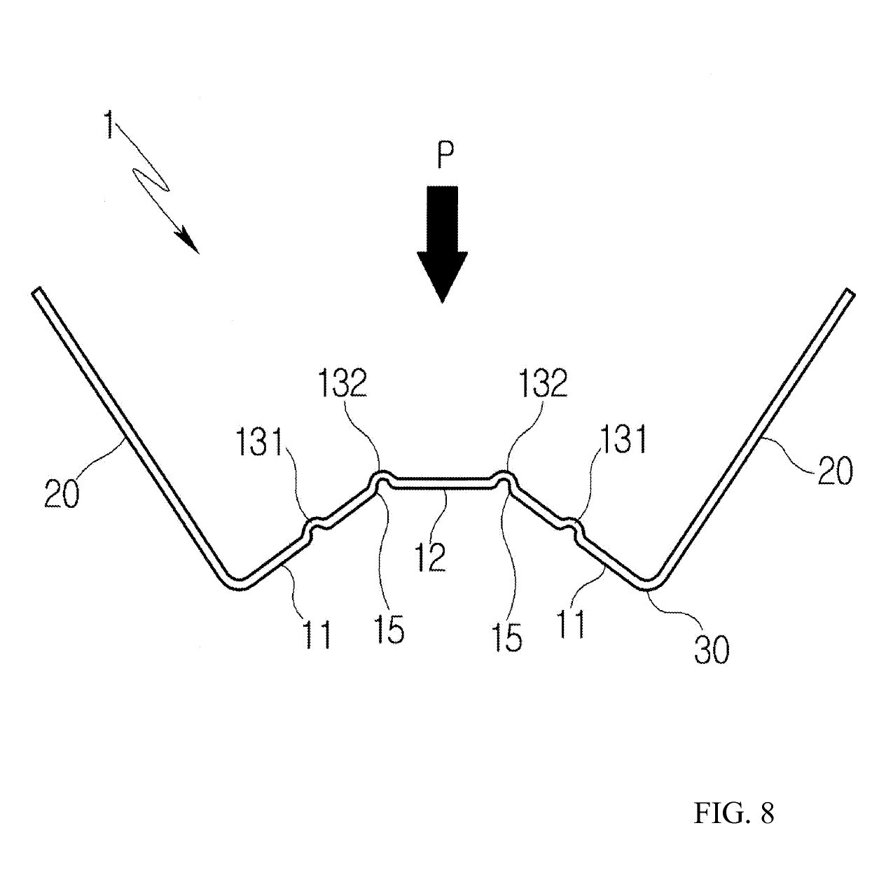

As shown in FIG. 8, each corner part 30 at which the corresponding first upper surface part 11 is joined with the associated pre-side surface part 20 is formed at the right angle so that the side surface parts 120 and the upper surface part 110 of the upper housing 100 having a U shape can be formed. That is, each corner part 30 is formed at first at the right angle by pressing to have the same shape as the final shape of the corresponding part of the upper housing 100. Subsequently, when the bending process is performed, only the bending parts 15 other than the corner parts 30 are bent.

When each first upper surface part 11 is bent by an angle obtained by subtracting a bending angle (α) from 180°, the first upper surface parts 11 along with the second upper surface part 12 form the upper surface part 110 of the upper housing 100. In this case, the pre-side surface parts 20 along with the first upper surface parts 11 are also moved by the same angle. A restoration angle (β) of each pre-side surface part 20 with respect to a pressing direction P depends on the bending angle (α) because the restoration angle (β) is a value obtained by subtracting the bending angle (α) from 180°. As the bending angle (α) is increased, the restoration angle (β) is reduced. When the pressing process is conducted as shown in FIG. 6A, as the restoration angle (β) is increased, the compression strength of the pre-side surface part 20 is increased, and the precision in shape of a pressed product is also enhanced. However, if the restoration angle (β) is increased, the bending angle (α) is reduced. Thus, the same problem as that caused when the restoration angle (β) of the pre-side surface parts 20 is reduced is induced from the first upper surface parts 11.

For instance, if the bending angle (α) is reduced, the strain of each bending part 15 is increased. Thereby, effects of stress applied to the bending part 15 are increased, and there is the probability of fracture of the bending part 15. If the bending angle (α) is increased, the strain of each bending part 15 is reduced, but it becomes difficult to conduct the process of pressing the pre-side surface parts 20. Therefore, it is preferable that the restoration angle (β) of the pre-side surface parts 20 be comparatively large and the bending angle (α) of the first upper surface parts 11 be also comparatively large. For this, the second upper surface part 12 is provided between the two first upper surface parts 11.

The second upper surface part 12 is formed to have a predetermined bending angle (α) relative to each first upper surface part 11 by means of the corresponding bending part 15. The two bending parts 15 are formed on opposite sides of the second upper surface part 12. Each bending part 15 has a bending angle (α) of an obtuse angle. In other words, the angle between each first upper surface part 11 and the second upper surface part 12 is an obtuse angle. Here, due to the second upper surface part 12, the bending angle (α) can be an obtuse angle close to 180°.

As such, if the bending angle (α) is an obtuse angle close to 180°, when the bending process is performed to make the first upper surface parts 11 be level with the second upper surface part 12, the angle to which each bending part 15 is bent can be reduced. Thereby, the strain of the bending part 15 can be reduced. Therefore, the durability of the bending part 15 can be enhanced, and the flatness thereof can also be increased.

The bead parts 130 for prevention of deformation are formed on the pre-upper surface part 10. The first beads 131 of the bead parts 130 are formed on the respective first upper surface parts 11. The second beads 132 are formed on the respective bending parts 15.

As shown in FIG. 8, since the second beads 132 are formed on the respective bending parts 15, the bending process can be facilitated, and stress resulting from bending of the bending parts 15 can be dispersed. That is, each second bead 132 has a rod shape extending along the corresponding bending part 15 so that the bending part 15 can be easily bent around the second bead 132. Since the second bead 132 has an arc-shaped cross-section, stress resulting from bending of the bending part 15 is dispersed to a wider area, whereby deformation can be reduced.

After the housing panel 1 has been manufactured, the bending process is conducted, as shown in FIG. 6B.

During the panel bending process, the two bending parts 15 formed on the pre-upper surface part 10 are bent to form the upper housing 100 having a U shape. In detail, the bending process is a process of bending the bending parts 15 formed on the pre-upper surface part 10 such that the pre-upper surface 10 becomes planar.

Here, the two corners 30 are maintained in the condition, in which they are bent at the right angle in the panel forming operation, without being separately bent. Therefore, the upper housing 100 can be formed by merely bending the bending parts 15 once.

As described above, in a method for manufacturing a housing of an exhaust gas recirculation cooler and a housing panel therefor in accordance with the present invention, the number of bending processes is reduced so that torsion caused by stress resulting from bending can be reduced. In addition, torsion can be minimized by bead parts. As a result, the flatness can be enhanced, the strength thereof against external force or internal pressure can be increased, and the stiffness against residual stress generated when a press process is conducted can be maintained.

Although the exemplary embodiment of the present invention has been disclosed for illustrative purposes, it will be appreciated that the present invention is not limited thereto, and those skilled in the art will appreciate that various modifications, additions, and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

1. A housing panel of an exhaust gas recirculation cooler which is used to manufacture a housing that houses therein a cooling module for cooling recirculation exhaust gas of a vehicle, the housing panel comprising:
a pair of pre-side surface parts forming respective side surface parts of the housing; and
a pre-upper surface part forming an upper surface part of the housing, the pre-upper surface part being integrally formed between the pair of pre-side surface parts, with two bending parts formed in the pre-upper surface part at positions spaced apart from each other by a predetermined distance, each of the two bending parts having an obtuse angle.

2. The housing panel according to claim 1, wherein the pre-upper surface part comprises:
a pair of first upper surface parts each integrally provided at a right angle on an edge of the corresponding pre-side surface part; and
a second upper surface part provided between the pair of first upper surface parts, with an obtuse angle formed between the second upper surface part and each of the first upper surface parts by the corresponding bending part.

3. The housing panel according to claim 1, wherein a bead part for deformation prevention is formed in a depressed form in the pre-upper surface part of the housing.

4. The housing panel according to claim 3, wherein the bead part is formed in each of the bending parts.

5. The housing panel according to claim 3, wherein the bead part comprises bead parts formed in the respective first upper surface parts to be symmetrical with each other based on the second upper surface part.

6. A method for manufacturing a housing of an exhaust gas recirculation cooler, comprising:
forming the housing panel of claim 1; and
flattening, through bending, the bending parts of the housing panel made in forming the housing panel.
